(19) United States
(12) Patent Application Publication
(10) Pub. No.: US 2019/0171834 A1
(43) Pub. Date: Jun. 6, 2019

(54) SYSTEM AND METHOD FOR DATA MANIPULATION

(71) Applicant: Deborah Logan, Los Angeles, CA (US)

(72) Inventor: Deborah Logan, Los Angeles, CA (US)

(21) Appl. No.: 15/833,002

(22) Filed: Dec. 6, 2017

(51) Int. Cl. G06F 21/62; G06F 17/30

(52) U.S. Cl. CPC G06F 21/6218; G06F 17/30041; G01S 19/42; G06F 17/30362; G06F 17/30035

(57) ABSTRACT

A system of dynamic data redaction within a computing device comprises a computing device having at least one processor, storage media, and a visual interface, wherein the computing device is in communication with one or more networks. The processor executes instructions for dynamic redaction of data using a method comprising the steps of presetting content to be redacted; the system submitting an inquiry over the one or more networks, wherein the inquiry retrieves tagged data; the system searching the retrieved data based on the preset content to be redacted; and the system blocking visual presentation of the redacted data.

### CROSS-REFERENCE TO RELATED APPLICATION(S)

Not applicable

### BACKGROUND OF THE INVENTION

### 1. Field of Invention

The present invention relates to the field manipulation of electronically stored data, and more particularly to selective editing of electronically stored documents.

### 2. Description of Related Art

Advancement in technology now provide for data to be stored and presented through a variety of electronic means. Computing devices with processors capable of executing stored instructions recall the data, based on predetermined user input, and present the data to the user on a display. The most relevant example of such a process involves the presentation of text, such as electronic books (ebooks) to a user on a mobile device. Whether the text was initially published as a traditional paper based tangible book, or created in an electronic environment, users rely on such data for recreational reading or informational transmission of current events.

The current state of technology, as it relates to such data accessibility has also presented a number of moral, ethical, and personal issues relating to the ease of access to text containing language, which is undesirable to the user. Absent any initial safeguards, anyone can access any information, even where such information is harmful or disturbing to the user.

Children may be at the forefront of the issue regarding access to text, which contains inappropriate language or content. The argument refers to a desire of the parents or guardians to meter or regulate the exposure their children may have to certain complex subject matter which may inappropriately affect the child's perception of reality. Obscene material can easily traumatize a child even though such an outcome is not the intended result of the data. Further, a child's ability to comprehend and manage such information may be insufficient compared to the formal reasoning of an adult.

Not only are children affected, but also adults who do not wish to read certain content, but still wish to have access to the text or information as a whole.

Current attempts to curtail undesirable content have come under extreme scrutiny from both the publisher, the courts, and the public having different subjective opinions of the work. Redacting content generally involves a long and laborious physical endeavor of reading the work, identifying material to be redacted, and then crossing it out or otherwise removing the legibility of the redacted portions.

Other more extreme methods involve may involve redacting or preventing access to the work as a whole. This is problematic as certain works may only have select portions of inappropriate material in combination with materials of historical or educational significance.

Based on the foregoing, there is a need in the art for a system that will allow for the selective redaction of content within an electronic environment. A system is needed to prevent the need to have the reader review the entire work to select the material to be redacted, or requiring a dedicated reader to do the same. Further, a system is needed that will allow for only selective redaction of predetermined subject matter, trigger words, or content without the need to remove access to the entire work.

### SUMMARY OF THE INVENTION

A system of dynamic data redaction within a computing device comprises a computing device having at least one processor, storage media, and a visual interface, wherein the computing device is in communication with one or more networks. The processor executes instructions for dynamic redaction of data using a method comprising the steps of presetting content to be redacted; the system submitting an inquiry over the one or more networks, wherein the inquiry retrieves tagged data; the system searching the retrieved data based on the preset content to be redacted; and the system blocking visual presentation of the redacted data.

In an embodiment, the step of presetting the content to be redacted further comprises the steps of inputting one or more words, categories, or images, wherein the one or more words, categories, or images are the content; and inputting a value, wherein the value is associated with the content, wherein the value is input based on predetermined importance of redaction of the content.

In an embodiment, the computing device further comprises a global positioning system, wherein the global positioning system inputs location of the computing device, wherein the inquiry is directed to local data relative to the location of the mobile device.

In an embodiment, the system further comprises the step of locking the system in an initiated state.

In an embodiment, the system further comprises the steps of verifying the redacted content, wherein the verified redacted content is input into a profile; and generating the profile based on repeated presetting of content to be redacted.

The foregoing, and other features and advantages of the invention, will be apparent from the following, more particular description of the preferred embodiments of the invention, the accompanying drawing(s), and the claims.

### BRIEF DESCRIPTION OF THE FIGURES

FIG. 1 illustrates a schematic flow chart diagram of the system, according to an embodiment of the present invention.

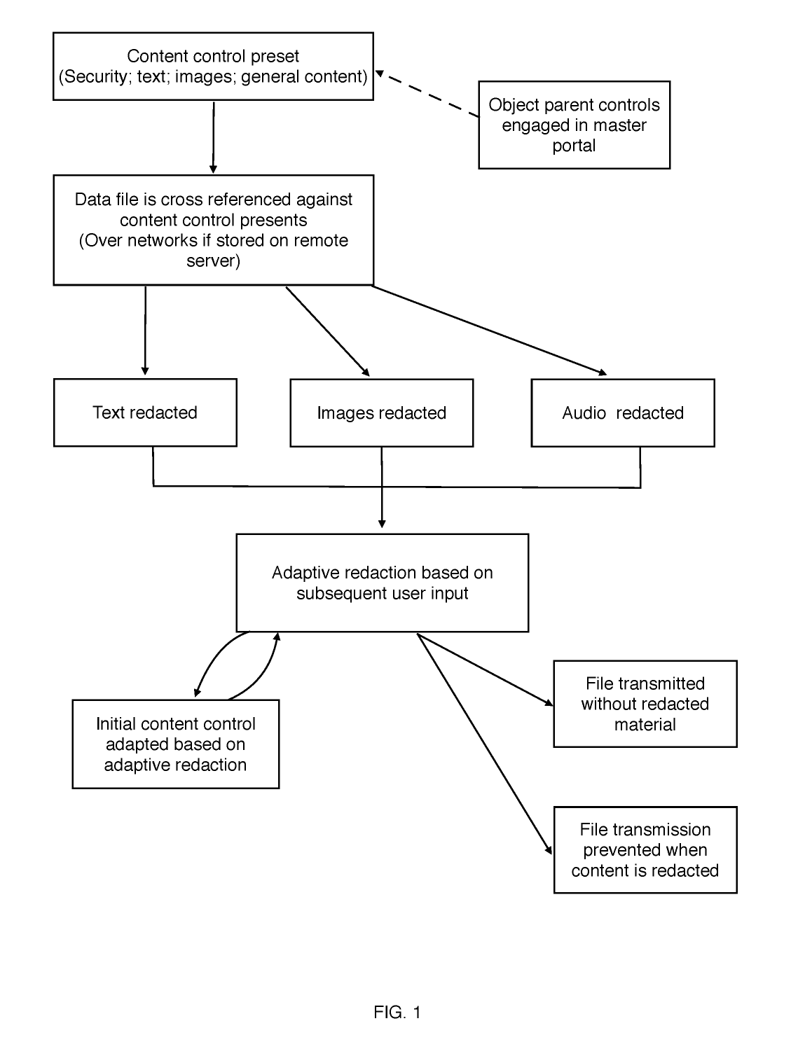

### DETAILED DESCRIPTION OF PREFERRED EMBODIMENTS

Embodiments of the invention are discussed below with reference to the FIGURE(S). However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawing(s).

From reading the present disclosure, other variations and modifications will be apparent to persons skilled in the art. Such variations and modifications may involve equivalent and other features which are already known in the art, and which may be used instead of or in addition to features already described herein.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

Strykout is a system operating within a computing device and environment. The computing device has at least one processor, a power source, a non-transitory storage media, a visual display, and a graphical user input (GUI) or other input device allowing user input for recall and selection of data within the system. The computing device components are in electrical communication with each other. Further, the computing device is in communication with one or more networks. The networks may be wired or wireless and the networks may also include remote databases.

The system is initially setup on the computing device whereby a user initiates the system by engaging the GUI. The system interacts with the computing components including the processor, network connectivity components, and a global positioning system (GPS). The GPS provides geolocation information regarding the computing device. Where the computing device is a mobile device, the GPS provides real-time location information to the system.

In an embodiment, the location information is considered and integrated into one or more algorithms operating within the system. The location information is used as the system submits one or more inquiries across the networks. In such an embodiment, the inquiries are submitted autonomously by the system and are directed to data stored within the one or more databases, where the data is geographically based. For example, where the mobile device is identified to be a particular geographical location, the system prepares and submits an inquiry for location-based data, such as a newspaper or publication containing current events. A response to the inquiry includes tagged data cross referenced with the geographical location.

In another embodiment, the data is stored within the computing device in the storage media. The user may download or upload data to be stored locally within the device, or on a cloud-based database. The data is selectively recalled by the user based on a unique identifier, such as a title or file name. For example, the user may download and store ebooks on the computing device, or access ebooks from a remote database.

Once the system has accessed the data, the data is cross-referenced with a plurality of predetermined and preset attributes input by the user. The user engages the GUI to establish parameters and attributes regarding the selective redaction of material and content within the data. Examples of the attributes preset by the user may include specific words, phrases, and images that the user determines to be undesired information.

In an embodiment, the user submits information into the system on a subjective scale providing a quantifiable or numerical to the importance of the extent of redaction of the material. For example, the user inputs an undesirable word. The word is presented in the traditional spelling and attributes of the word within the data, such as capitalization, or other visual edits (bold, italics, underlining) are provided to the user by the system as suggested alternative presentations of the word. The user then selects a numerical value on a scale relating to the level of importance for the system to identify and redact the word. In such an embodiment, the data may present the word in a non-traditional font. However, based on the level of importance, the system may act in a conservative manner and redact words closely related to the specifically identified word.

In an embodiment, images are undesirable content which the user can identify in the system. The system may store categories of imagery to be removed. For example, nude images may be determined to be undesirable by the user. The user may select for such categories of images and provide valuation of importance. The valuation of importance further defines the extent of searching of the data by the system for redaction. In an example, where nudity is selected to be redacted, the system recalls preset valuation of pixel coloration relating to skin tone. The system will then search the data file for the code relating to skin tone images within the data. Once identified, the location of the skin tone codes is redacted or removed from the data.

In another embodiment, the user may select preset categories of text within the data to be removed. The system may provide for preset categories of such data. For example, vulgar language including sexual or violent content may be a category including known words relating to such definition. The selection of a category for redaction results in the system submitting inquires across the data file to identify the words to be deleted.

Where content has been deleted or redacted from the data, a visual indicator such as a blackout line or other indicator (i.e. “xxxxxxxxx”) may replace the location of the redacted material within the text.

In an embodiment, the redacted content may also have an identifier embedded into the redacted visual indicator to allow the user to identify the rational for the redaction. The user may select the redacted data and review the redaction rational. In another embodiment, the redacted data may be provided in a footnote. The footnote may require verification or validation of the user to be able to access the data, which was redacted.

In an alternative embodiment, presets and inputs from the user are stored within the system. As the user continuously engages the system for dynamic redaction, the system identifies trends and creates a user profile based on the history of user selections. The profile may then be automatically applied to select data or to all data being presented by the system. The profile may be reviewed and altered by the user.

In an alternative embodiment, the system requires authentication and/or validation of the user accessing the system. For example, the system may be initiated within the computing device by a first user and then locked in an initiated mode for subsequent users.

Security settings may be provided by one or more users. In some embodiments, security settings are accessible selectively through a master portal. A secondary user portal is subject to the security controls preset by the master portal. For example, the master portal may be under the control of a parent. The controls allows for selective predetermined accessible information. Accessible information may include preset thresholds for modification to content of the one or more files accessed within the system. A specific example is where a parent accesses the master portal and is able to control security settings on a subjective or objective scale relating to the content the system is able to display. Categorical security settings may provide for “G; PG; PG-13; R; None” relating to an increasing open access of information.

In another embodiment, one or more indicators may be provided on the display in a visible location to visually indicate where one or more redactions have occurred. For example, an upper or lower corner may have a flag or other geometric shape on any page being displayed where one or more redactions have taken place.

In another embodiment, redacted material may be selectively locked for subsequent transmission or display of the data. For example, where a redaction is displayed and the user attempts to forward the complete data to a subsequent device, the redacted material will be removed from the data file for the purposes of the transmission. In such an embodiment, a user is prevented from circumventing redactions by subsequent transmission of the data. Another embodiment provides for a lock on the entire data file, thereby preventing transmission of a file entirely, when a redaction of material within the file has occurred.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A system of dynamic data redaction within a computing device comprising:
a. a computing device having at least one processor, storage media, and a visual interface, wherein the computing device is in communication with one or more networks, and wherein the processor executes instructions for dynamic redaction of data using a method comprising the steps of:
i. presetting content to be redacted;
ii. the system submitting an inquiry over the one or more networks, wherein the inquiry retrieves tagged data;
iii. the system searching the retrieved data based on the preset content to be redacted; and
iv. the system blocking visual presentation of the redacted data.

2. The system of claim 1, wherein the step of presetting the content to be redacted further comprises the steps of:
a. inputting one or more words, categories, or images, wherein the one or more words, categories, or images are the content; and
b. inputting a value, wherein the value is associated with the content, wherein the value is input based on predetermined importance of redaction of the content.

3. The system of claim 1, wherein the computing device further comprises a global positioning system, wherein the global positioning system inputs location of the computing device, wherein the inquiry is directed to local data relative to the location of the mobile device.

4. The system of claim 1, further comprising the step of locking the system in an initiated state.

5. The system of claim 1, further comprising the steps of:
a. verifying the redacted content, wherein the verified redacted content is input into a profile; and
b. generating the profile based on repeated presetting of content to be redacted.
